(19) United States
(12) Patent Application Publication
(10) Pub. No.: US 2020/0145397 A1
(43) Pub. Date: May 7, 2020

(54) CLOUD PLATFORM FOR DEVICE CONNETION AND A DEVICE CONNECTING METHOD

(71) Applicant: Institute For Information Industry, Taipei (TW)

(72) Inventors: Po-Hsuan WU, Taipei City (TW); Chih-Kai CHEN, Taipei City (TW)

(21) Appl. No.: 16/257,383

(22) Filed: Jan. 25, 2019

(30) Foreign Application Priority Data
Nov. 5, 2018 (TW) 107139178

(51) Int. Cl. H04L 29/06; H04L 29/08; H04L 9/32

(52) U.S. Cl. CPC H04L 63/067; H04L 67/12; H04L 9/321; H04L 67/22; H04L 67/141; H04L 63/0876

(57) ABSTRACT

A cloud platform for device connection and a device-connecting method. The cloud platform includes a service management module, a dynamic credential configuration service (DCCS) module and a connection management module. The service management module is configured to receive a connection-establishing request that includes a secret key and generate a first credential according to the secret key. The DCCS module is configured to receive and store the secret key and the first credential from the service management module. The connection management module is configured to record the first credential, and transmit a credential adjustment massage to the service management module after determining an abnormal connection condition. Then, the service management module is further configured to generate a second credential according to the secret key, record the second credential in the connection management module and store the second credential in the DCCS module.

### PRIORITY

This application claims priority to Taiwan Patent Application No. 107139178 filed on Nov. 5, 2018, which is hereby incorporated by reference in its entirety.

### FIELD

The present invention relates to a cloud platform for device connection and a device-connecting method. More specifically, the embodiments of present invention relate to a cloud platform and a device-connecting method which use a dynamic connection credential as the connection mechanism.

### BACKGROUND

When electronic devices are being deployed in a region, it is necessary to connect the electronic devices with a management center platform. A connection management platform will allocate a connection credential and a resource for each connected electronic device so that each electronic device may function normally.

When the connection management platforms in the prior art encounter situations such as service adjustment, equipment upgrade, equipment maintenance, shutdown, moving, or being attacked from the Internet; however, the connection between a connection management platform and devices will be disconnected. A need of manpower is necessary to reconfigure the connection credentials and resources between the devices and the connection management platform so that the devices may access the service and resources again. Therefore, the present connection mechanism between electronic devices and a connection management platform lacks flexibility and efficiency in terms of management.

Accordingly, an important goal exists in the art to provide a more efficient connection management platform so that electronic devices may be connected to the connection management platform more efficiently.

### SUMMARY

Provided herein is a cloud platform for device connection. The cloud platform can comprise a service management module, a dynamic credential configuration service (DCCS) module, and connection management module, wherein the service management module is electrically connected to the DCCS module and the connection management module. The service management module an be configured to receive a connection-establishing request which includes a secret key, and to generate a first connection credential according to the secret key. The DCCS module is configured to receive and store the secret key and the first connection credential from the service management module. The connection management module is configured to record the first connection credential; and to determine an abnormal connection and then to transmit a credential adjustment massage to the service management module. The service management module is further configured to generate a second connection credential according to the secret key; to record the second connection credential in the connection management module; and to store the second credential in the DCCS module.

Also provided is a device-connecting method, which is adapted for a cloud platform. The cloud platform can include a service management module, a dynamic credential configuration service (DCCS) module, and connection management module, wherein the service management module is electrically connected to the DCCS module and the connection management module. The device-connecting method may comprise: receiving, by the service management module, a connection-establishing request which includes a secret key; generating, by the service management module, a first connection credential according to the secret key; storing, by the service management module, the secret key and the first connection credential in the DCCS module, and recording, by the service management module, the first connection credential in the connection management module; determining, by the connection management module, an abnormal connection condition, and then transmitting, by the connection management module, a credential adjustment massage to the service management module; generating, by the service management module, a second connection credential according to the secret key after receiving the credential adjustment massage; and recording, by the service management module, the second connection credential in the connection management module, and storing, by the service management module, the second connection credential in the DCCS module.

The detailed technology and preferred embodiments implemented of the present invention are described in the following paragraphs accompanying the appended drawings for people skilled in this field to well appreciate the features of the claimed invention.

### BRIEF DESCRIPTION OF THE DRAWINGS

FIG. 1A and FIG. 1B are schematic views of operating conditions and block diagrams of a cloud platform of the first embodiment of the present invention;

FIG. 2 is a flow diagram of a device-connecting method of the second embodiment of the present invention;

FIG. 3 is a flow diagram of a device-connecting method of the third embodiment of the present invention; and

FIG. 4 is a flow diagram of a device-connecting method of the fourth embodiment of the present invention.

### DETAILED DESCRIPTION

In the following description, the present invention will be explained with reference to example embodiments thereof. These example embodiments are not intended to limit the present invention to any specific environment, examples, embodiments, applications or particular implementations described in these example embodiments. Therefore, description of these example embodiments is only for purpose of illustration rather than to limit the present invention.

In the following embodiments and the attached drawings, elements unrelated to the present invention are omitted from depiction; and dimensional relationships among individual elements in the attached drawings are provided only for ease of understanding, but not to limit the actual scale. Except for the specific explanation, identical (or similar) element symbols may correspond to the identical (or similar) elements in the following content.

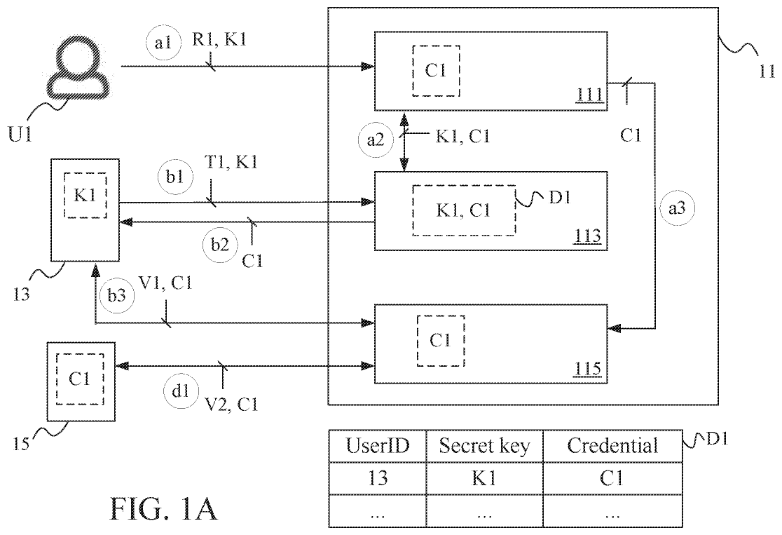

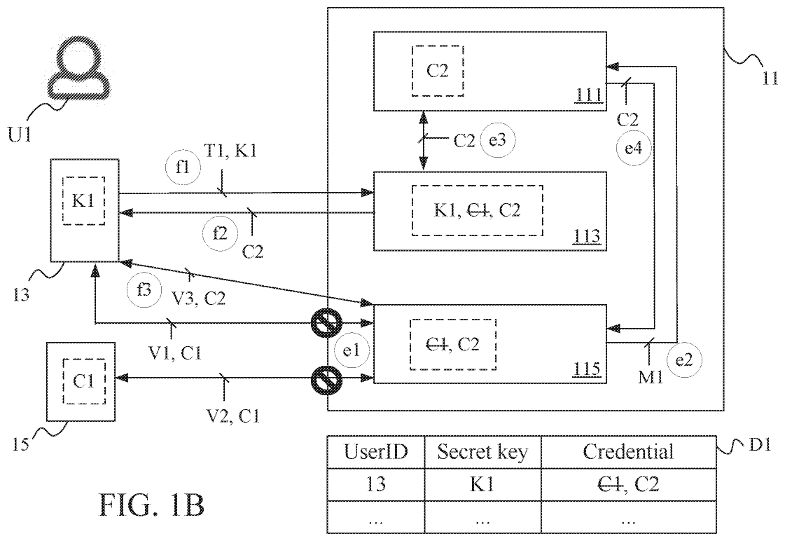

Please refer to FIG. 1A and FIG. 1B for the first embodiment of the present invention. FIG. 1A and FIG. 1B are schematic views of operating conditions and block diagrams of a cloud platform. FIG. 1A and FIG. 1B are only intended for explaining a specific embodiment of the present invention rather than for limiting the present invention. The labels a1˜a3, b1˜b3, dl, e1˜e4 and f1˜f3 are intended to assist in explanation, and they are not intended to limit the sequence relation unless the content specifies the sequence relation.

First, please refer to FIG. 1, the cloud platform 11 comprises a service management module 111, a dynamic credential configuration service (DCCS) module 113, and a connection management module 115. The service management module 111 is electrically connected to the DCCS module 113 and the connection management module 115. The interacting conditions among the cloud platform 11, a user U1, a first device 13 and a second device 15 are described in the following.

Please refer to the label a1, the cloud platform 11 may receive a connection-establishing request R1 from the user U1 to create a connection with the cloud platform 11 for the first device 13. The connection-establishing request R1 includes a secret key K1, and the secret key K1 belongs to the device 13. In other words, for the purpose of applying the first device 13 on the cloud platform 11, the user U1 inputs the secret key K1 of the first device 13 into the service management module 111. It shall be noted that the secret key K1 has the feature of uniqueness, which may be associated with the first device's a machine identification number, manufacture number, communication code, etc. or an identifier which is allocated by a system, but not limited thereto. For example, all of the devices are equipped with a unique identifier, and the identifier is used as a secret key and is recorded in the system. When an illegal device (i.e., a device without a legal identifier) tempts to connect to a system, the system may determine that the connection is an illegal connection according to the identifier. Furthermore, the equipment manufacturers may design a mechanism of storing and protecting a secret key for devices so that the secret key is well-protected and will not be obtained easily.

In an implementation, the user U1 transmits the connection-establishing request R1 via an electronic device such as a user application, a user interface, or a computer. The connection between the electronic device and the cloud platform may be a wired network (e.g., the optical fiber network, but not limited thereto) or a wireless network (e.g., the Wi-Fi, Bluetooth, mobile network, but not limited thereto).

After receiving the connection-establishing request R1, the service management module 111 may generate a first connection credential C1 according to the secret key K1. It shall be noted that the first connection credential C1 is the connection information belonging to the first device 13, for example, the first connection credential C1 may comprise a device name, a device password, an access address, a valid time or connection parameters.

Next, please refer to the label a2, the service management module 111 transmits the secret key K1 and the first connection credential C1 to the DCCS module 113. The DCCS module 113 stores the secret key K1 of the first device 13 and the first connection credential C1 which corresponds to the secret key K1. In an implementation, the secret key K1 and the first connection credential C1 are stored in a database D1. In an implementation, the database D1 may be stored in an independent storage, which is electrically connected with the DCCS module 113.

On the other hand, please refer to the label a3, the service management module 111 records the first connection credential C1 in the connection management module 115. More specifically, the service management module 111 register the first connection credential in the connection management module 115 so that the first connection credential C1 may be used for verification later and then the connection management module 115 may provide a resource, for example, data access, a storing space, or a service.

In other words, the aforesaid content about the label a1˜the label a3 mainly describes that the cloud platform 11 receives the connection-establishing request R1 which includes the secret key K1, and then the service management module 111 generates the first connection credential C1 for the first device 13, stores the secret key K1 and the first connection credential C1 in the DCCS module 113, and registers the first connection credential C1 in the connection management module 115.

Then, please refer to the label b1, the first device 13 transmits a credential exchange request T1 to the DCCS module 113, wherein the credential exchange request T1 includes the secret key K1. Next, please refer to the label b2, the DCCS module 113 verify the secret key K1 and then transmits the connection credential C1 to the first device 13. In other words, the first device 13 uses the secret key K1 which belongs to the device 13 to proceed the verification with the DCCS module 113 and receives the first connection credential C1. The DCCS module 113 may search the first connection credential C1 which corresponds to the secret key K1 in the database D1 according to the verified secret key K1 (e.g., the table recorded in the database D1 in FIG. 1A) and transmit the first connection credential C1 to the first device 13.

Next, please refer to the label b3, after receiving the first connection credential C1, the first device 13 may transmit a first connection request V1 to the connection management module 115, wherein the first connection request V1 includes the first connection credential C1. The connection management module 115 verifies the received first connection credential C1 according to the recorded first connection credential C1, confirms that the first connection credential C1 is legal, and then provides the first device 13 with a first resource.

In other words, the aforesaid content of the label b1˜the label b3 mainly describes that the first device 13 sends the unique secret key K1 to the DCCS module 113 to obtain the first connection credential C1, and then uses the obtained first connection credential C1 to establish connection with connection management module 115 for utilizing a resource and a service.

According to the content of the label a1˜the label a3, the first connection credential C1 has been recorded in the connection management module 115. However, the first connection credential C1 of the first device 13 may be laterally recorded or stolen by a second device 15 with vicious intention. Therefore, under some circumstances, the second device 15 may have the first connection credential C1 and disguise itself as the first device 13 to use the first device 13's resource.

Then, please refer to the label dl, the connection management module 115 receives a second connection request V2 from the second device 15, wherein the second connection request V2 includes a first connection credential C1. In other words, the second device 15 obtains the first connection credential C1 via an illegal mean and attempts to establish a connection with connection management module 115 in order to use the first device's access control, for example, account, data, or services.

Next, please refer to FIG. 1B and the label e1, the connection management module 115 receives a second connection request V2, determines an abnormal connection condition based on the first connection credential C1 and then disconnects the connection based on the connection credential C1. More specifically, the connection management module 115 is equipped with the function of monitoring a connection to determine whether any connection request including any connection credential is sent from the electronic device which applies the connection credential, to determine whether the connection credential is legal, or to determine whether the connection credential is within valid period.

For example, the connection management module 115 may monitor the condition of multiple logins, a network address, the number of logins, a frequency of logging in, the number of accessing data, etc. or the connection management module 115 may check the action of exchanging a credential with the DCCS module 113, but not limited thereto.

In other words, the connection management module 115 may disconnect the connection based on the first connection credential C1 after determining an abnormal connection condition. Therefore, both of the first device 13 and the second device 15 which use the first connection credential cannot establish connection with the connection management module 115. It shall be noted that, in one or some implementations, the function of monitoring connection may be independently set as a monitoring module, which is configured to monitor the connection of the connection management module 115.

Next, please refer to the label e2, after the connection management module 115 determines the abnormal connection condition based on the first connection credential C1, the connection management module 115 transmits a credential adjustment massage M1 to the service management module 111. The service management module 111 generates a second connection credential C2 according to the secret key K1 after receiving the credential adjustment massage M1.

Next, please refer to the label e3, the service management module 111 transmits the second connection credential C2 to the DCCS module 113. The DCCS module 113 stores the second connection credential C2, and updates the secret key K1 to correspond to the second connection credential C2. In other words, the first connection credential C1 in the database D1 is replaced with the second connection credential C2, and the secret key K1 corresponds to the second connection credential C2.

On the other hand, please refer to the label e4, the service management module 111 transmits the second connection credential C2 to connection management module 115. In short, the service management module 111 registers the second connection credential C2 in the connection management module 115 and invalidates the first connection credential C1.

The aforesaid content of the label e1˜the label e4 mainly describes that the cloud platform 11 proceeds a procedure after determining or detecting an abnormal connection condition, and that the connection management module 115 transmits the credential adjustment massage M1 to the service management module 111. Then, the service management module 111 generates the second connection credential C2 according to the secret key K1, and indicates the DCCS module 113 and the connection management module 115 to replace the first connection credential C1 with the second connection credential C2.

In the first embodiment, the abnormal connection condition is described with an example condition that an unknown device steals the connection credential to establish a connection, but the abnormal connection condition is not limited thereto. For example, the abnormal connection condition may be a condition of disconnecting, a condition of the expiry credential, a change of service, a change of resource, the certain number of accessing data which is reach, etc. so that the connection management module 115 interrupts the connection based on the first connection credential C1 and further trigger the service management module 111 to generate the second connection credential C2.

In an implementation, the service management module 111 may obtain the secret K1 from the DCCS module 113 to generate the second connection credential C2. In another implementation, the service management module 111 may notify the user U1 and then obtain the secret key K1 to generate the second connection credential C2, but the present invention is not limited thereto.

Next, please refer to the label f1, since the first connection credential C1 which is recorded in the connection management module 115 is invalid now, the first device find out that the first connection credential C1 cannot be used to establish a connection. Therefore, the first device 13 transmits the credential exchange request T1 to the DCCS module 113, wherein the credential exchange request T1 includes the secret key K1. Then, please refer to the label f2, the DCCS module 113 searches the corresponding second connection credential C2 in the updated database D1 according to the secret key K1, and then transmits the second connection credential C2 to the first device 13. Afterwards, please refer to the label f3, the first device 13 transmits a third connection request V3 to the connection management module 115 for verification and for establishing a connection, wherein the third connection request V3 includes the second connection credential C2. Subsequently, the connection management module 115 may provide the first device 13 with a second resource.

In other words, the secret key K1 of the first device 13 has been recorded in the cloud platform 11. When an abnormal connection happens, the cloud platform 11 may update the connection credential for the first device 13. In the situation that the first device 13 cannot connect to the cloud platform 11 with the previous connection credential, the first device 13 may use the secret key K1 to obtain the updated connection credential so that the first device 13 may continue to use the resource of the cloud platform 11.

In one or some implementations, the resources accessed with the second connection credential C2 and the first connection credential C1 are the same resources, for example, address of storing data, transmission path of data, or transmission speed of data, but not limited thereto. In one or some implementations, the resources accessed with the second connection credential C2 and the first connection credential C1 are the different resources, for example, address of storing data, transmission path of data, or transmission speed of data, but not limited thereto.

As for the aforesaid relevant operations of the label e1˜the label e4, the aforesaid relevant operations of the label b1˜the label b3 are not the necessary antecedent steps. On the other hand, the relevant operations of the label e1˜the label e4 are the basis of the aforesaid relevant operations of the label f1˜the label f3. The relevant descriptions of the label b1˜the label b3 and the label e1˜the label e4 are intended to make the operations more complete and easier to understand. In other words, since the purpose of the cloud platform 11 is to change the first connection credential C1 to the second connection credential C2, the relevant operations of the label b1˜the label b3 and label e1˜the label e4 may be selective.

The service management module 111, the DCCS module 113 and the connection management module 115 may comprise necessary hardware and circuits such as at least one processor and at least one storage for storing and processing data or circuit signals. Further, people skilled in the art is capable to design the relevant circuits of the service management module 111, the DCCS module 113 and the connection management module 115 of the present invention according to the known circuits such as a processor and a storage. Therefore, the details of the processor and the storage are omitted.

In one or some implementations, after the connection management module 115 determines the abnormal connection condition, the connection management module 115 is further configured to disconnect the connection with the second connection device 15 to make sure the account security of the first device 13.

In one or some implementations, the service management module 111 is further configured to withdraw the first connection credential C1 stored in the connection management module 115 after receiving the credential adjustment massage M1.

In one or some implementations, the connection management module 115 is further configured to monitor the number of data access to the resource that is based on the first connection credential C1. When the number of the data access reach the upper limitation of service, the connection management module 115 may determine that the connection is a kind of abnormal connection condition. After the user U1 extends the contract of using the cloud platform 11 for the first device 13, the service management module 111 is further configured to generate the second connection credential C2 for the secret key K1.

In one or some implementations, the second resource and the first resource are the same resource. In other words, the cloud platform may merely update the account information (e.g., account number, password, but not limited thereto).

In one or some implementations, the second resource is different from the first resource. In other words, the cloud platform 11 may provide different resource (e.g., transmission path of data, storing space of data, but not limited thereto).

In one or some implementations, the DCCS module 113 further comprises an independent storage for storing the database D1. In other words, the secret key K1, the first connection credential C1 and the second connection credential C2 are stored in an independent storage to protect the security of data.

In one or some implementations, the cloud platform 11 further comprises a transmission interface (not shown), wherein the transmission interface is electrically connected to the service management module 111, the DCCS module 113 and the connection management module 115. The transmission interface is configured to be used as the only data transmission interface to other external devices. In other words, the cloud platform 11 receives or transmits the data with the user and electronic device via the transmission interface.

In one or some implementations, the cloud platform 11 is adapted for a connection service of Internet of Things.

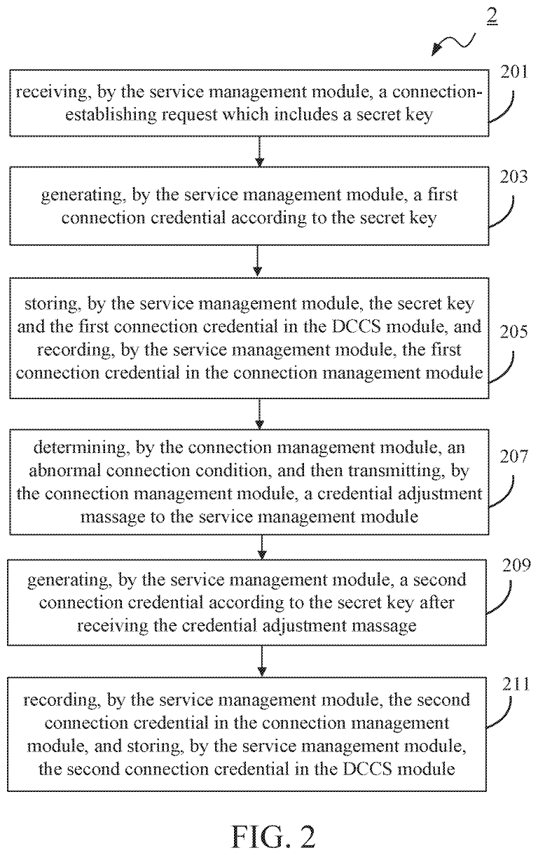

Please refer to FIG. 2 for the second embodiment of the present invention. FIG. 2 illustrates a flow diagram of a device-connecting method 2. The device-connecting method 2 is adapted for a cloud platform (e.g., the cloud platform 11 of the first embodiment). The cloud platform comprises a service management module, a DCCS module, and a connection management module, wherein the service management module is electrically connected to the DCCS module and the connection management module.

The device-connecting method 2 comprises the following steps of: in the step 201, receiving, by the service management module, a connection-establishing request, which includes a secret key; in the step 203, generating, by the service management module, a first connection credential according to the secret key; in the step 205, storing, by the service management module, the secret key and the first connection credential in the DCCS module, and recording, by the service management module, the first connection credential in the connection management module; in the step 207, determining, by the connection management module, an abnormal connection condition, and then transmitting, by the connection management module, a credential adjustment massage to the service management module; in the step 209, receiving, by the service management module, the credential adjustment massage, and then generating, by the service management module, a second connection credential according to the secret key; and in the step 211, recording, by the service management module, the second connection credential in the connection management module, and storing, by the service management module, the second connection credential in the DCCS module.

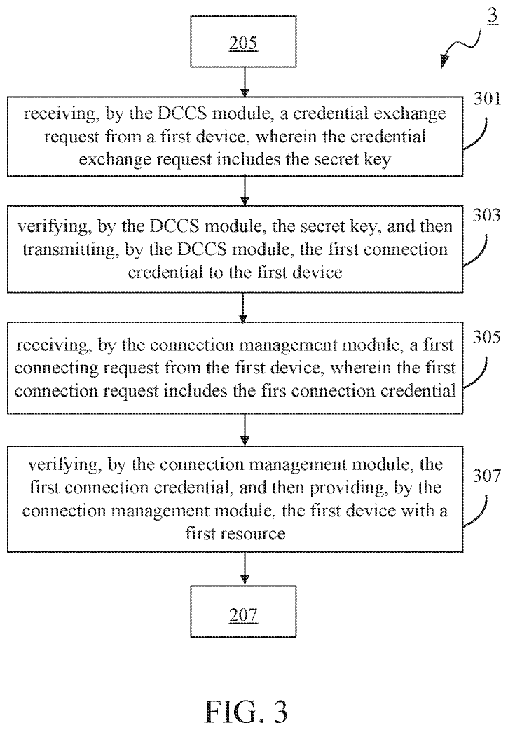

Please refer to FIG. 3 for the third embodiment, which is the device-connecting method 3. The device-connecting method 3 is an extension of the device-connecting method 2 and comprises all of steps in the device-connecting method 2. Therefore, the steps 201, 203, 205, 207, 209 and 211 in FIG. 2 are not repeatedly described.

In addition to the steps 201, 203, 205, 207, 209 and 211, the device-connecting method 3 further comprises the following steps between the step 205 and the step 207: in the step 301, receiving, by the DCCS module, a credential exchange request from a first device, wherein the credential exchange request includes the secret key; in the step 303, verifying, by the DCCS module, the secret key, and then transmitting, by the DCCS module, the first connection credential to the first device; in the step 305, receiving, by the connection management module, a first connecting request from the first device, wherein the first connection request includes the first connection credential; and in the step 307, verifying, by the connection management module, the first connection credential, and then providing, by the connection management module, the first device with a first resource.

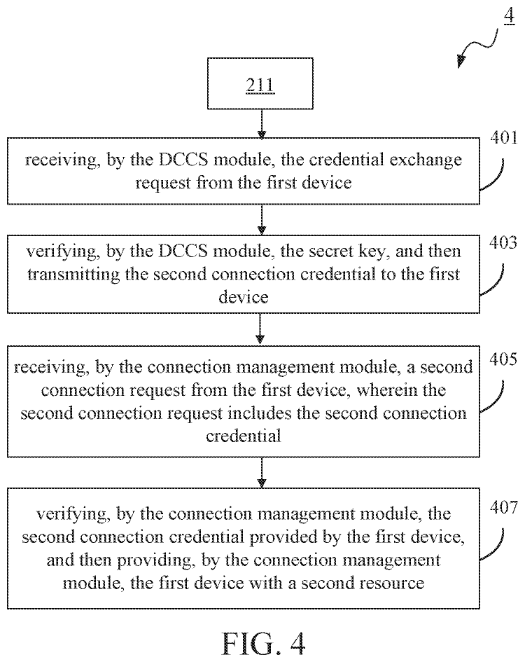

Please refer to FIG. 4 for the third embodiment, which is the device-connecting method 4. The device-connecting method 4 is an extension of the device-connecting method 3 and comprises all of steps in the device-connecting method 3. Therefore, the steps 201, 203, 205, 207, 209 and 211 in FIG. 2 and the steps 301, 303, 305 and 309 are not repeatedly described.

In addition to the steps 201, 203, 205, 207, 209 and 211, the device-connecting method 3 further comprises the following steps after the steps 211: in the step 401, receiving, by the DCCS module, the credential exchange request from the first device; in the step 403, verifying, by the DCCS module, the secret key, and then transmitting the second connection credential to the first device; in the step 405, receiving, by the connection management module, a first connecting request from the first device, wherein the first connection request includes the first connection credential; and in the step 407, verifying, by the connection management module, the first connection credential, and then providing, by the connection management module, the first device with a first resource.

In one or some implementations, the abnormal connection condition is a third connection request, wherein the third connection request comes from a second device and comprises the first connection credential. Moreover, the device-connecting method further comprises the following step of: disconnecting, by the connection management module, the connection with the second device.

In one or some implementations, the device-connecting method further comprises the following step of: withdrawing, by the service management module, the first connection credential recorded by the connection management module.

In one or some implementations, the device-connecting method further comprises the following step of: Monitoring, the connection management module, a data access frequency based on the first connection credential.

In one or some implementations, the DCCS module further comprises a database, which is configured to store the secret key, the first connection credential and the second connection credential.

In one or some implementations, the device-connecting method is further adapted for a connection service of Internet of Things (IoT).

The terms “first”, “second” and “third” are used to distinguish the things with similar quality and to understand the feature of the present invention more easily rather than limit the sequence relation unless the sequence relation is emphasized in the content.

In some embodiment, the device-connecting method which is adapted for a cloud platform corresponds to the cloud platform and is equipped with the corresponding steps to achieve the cloud platform. Similarly, the cloud platform may correspond to the device-connecting method adapted for cloud platform. In addition to the aforesaid steps, group marketing method of the present invention can also execute all the operations described in the aforesaid embodiments and have all the corresponding functions, and how this embodiment executes these operations and has these functions based on the aforesaid embodiments shall be readily appreciated by those of ordinary skill in the art, and thus will not be further described herein. Besides, in the condition that the features do not conflict with each other, the aforesaid embodiments and implementations can be combined as an embodiment.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A cloud platform for device connection, comprising:
a service management module, being configured to:
receive a connection-establishing request, which includes a secret key; and
generate a first connection credential according to the secret key;
a dynamic credential configuration service (DCCS) module, electrically connected to the service management module and being configured to:
receive and store the secret key and the first connection credential from the service management module; and
a connection management module, electrically connected to the service management module and being configured to:
record the first connection credential; and
determine an abnormal connection condition, and then transmit a credential adjustment massage to the service management module;
wherein after receiving the credential adjustment massage, the service management module is further configured to:
generate a second connection credential according to the secret key;
record the second connection credential in the connection management module; and
store the second credential in the DCCS module.

2. The cloud platform of claim 1, wherein:
the DCCS module is further configured to:
receive a credential exchange request, which includes the secret key; and
verify the secret key, and then transmit the first connection credential to the first device;
the connection management module is further configured to:
receive a first connection request from the first device, wherein the first connection request includes the connection credential; and
verify the first connection credential and then provide the first device with a first resource.

3. The cloud platform of claim 2, wherein:
the DCCS module is further configured to:
receive the credential exchange request from the first device; and
verify the secret key and then transmit the second credential to the first device;
the connection management module is further configured to:
receive a second connection request, which includes the second connection credential;
verify the second connection credential provided by the first device and then provide the first device with a second resource.

4. The cloud platform of claim 1, wherein the abnormal connection condition is a third connection request, which is from a second device and includes the first connection credential.

5. The cloud platform of claim 4, wherein the connection management module is further configured to disconnect the connection with the second device.

6. The cloud platform of claim 1, wherein the service management module is further configured to withdraw the first connection credential recorded by the connection management module.

7. The cloud platform of claim 1, wherein the cloud platform is adapted for a connection service of Internet of Things (IoT).

8. The cloud platform of claim 1, wherein the connection management module is further configured to monitor a data access frequency based on the first connection credential.

9. The cloud platform of claim 1, wherein the DCCS module further includes a database, which stores the secret key, the first connection credential and the second connection credential.

10. A device-connecting method, being adapted for a cloud platform which includes a service management module, a management (DCCS) module and a connection management module, the device-connecting method comprising the following steps of:
receiving, by the service management module, a connection-establishing request which includes a secret key;
generating, by the service management module, a first connection credential according to the secret key;
storing, by the service management module, the secret key and the first connection credential in the DCCS module, and recording, by the service management module, the first connection credential in the connection management module;
determining, by the connection management module, an abnormal connection condition, and then transmitting, by the connection management module, a credential adjustment massage to the service management module;
generating, by the service management module, a second connection credential according to the secret key after receiving the credential adjustment massage; and
recording, by the service management module, the second connection credential in the connection management module, and storing, by the service management module, the second connection credential in the DCCS module.

11. The device-connecting method of claim 10, wherein the device-connecting method further comprises the following steps of:
receiving, by the DCCS module, a credential exchange request from a first device, wherein the credential exchange request includes the secret key;
verifying, by the DCCS module, the secret key, and then transmitting, by the DCCS module, the first connection credential to the first device;
receiving, by the connection management module, a first connecting request from the first device, wherein the first connection request includes the first connection credential; and
verifying, by the connection management module, the first connection credential, and then providing, by the connection management module, the first device with a first resource.

12. The device-connecting method of claim 11, wherein the device-connecting method further comprises the following steps of:
receiving, by the DCCS module, the credential exchange request from the first device;
verifying, by the DCCS module, the secret key, and then transmitting the second connection credential to the first device;
receiving, by the connection management module, a second connection request from the first device, wherein the second connection request includes the second connection credential; and
verifying, by the connection management module, the second connection credential provided by the first device, and then providing, by the connection management module, the first device with a second resource.

13. The device-connecting method of claim 10, wherein the abnormal connection condition is a third connection request, and wherein the third request is from a second device and includes the first connection credential.

14. The device-connecting method of claim 13, wherein the device-connecting method further comprises the following step of: disconnecting, by the connection management module, the connection with the second device.

15. The device-connecting method of claim 10, wherein the device-connecting method further comprises the following step of:
withdrawing, by the service management module, the first connection credential recorded by the connection management module.

16. The device-connecting method of claim 10, wherein the device-connecting method is adapted for a connection service of Internet of Things (IoT).

17. The device-connecting method of claim 10, wherein the device-connecting method further comprises the following step of:
monitoring, the connection management module, a data access frequency based on the first connection credential.

18. The device-connecting method of claim 10, wherein the DCCS module further comprises a database, which is configured to store the secret key, the first connection credential and the second connection credential.
